(19) United States
(12) Patent Application Publication
(10) Pub. No.: US 2026/0192644 A1
(43) Pub. Date: Jul. 9, 2026

(54) Tonneau Cover Holddown System

(71) Applicant: Leer Group, Elkhart, IN (US)

(72) Inventor: Eugene A. Dylewski, II, Granger, IN (US)

(21) Appl. No.: 19/339,418

(22) Filed: Sep. 25, 2025

Related U.S. Application Data
(60) Provisional application No. 63/700,180, filed on Sep. 27, 2024.

(51) Int. Cl. B60J 7/14

(52) U.S. Cl. CPC B60J 7/141

(57) ABSTRACT

A tonneau cover holddown assembly for securing a bulkhead panel of a tonneau cover to a rail positioned on a sidewall of a cargo box of a truck is provided. The tonneau cover holddown assembly includes: a slot disposed through an underside surface of the bulkhead panel. The slot including a keyhole. A bolt including a bolthead is sized to fit through the keyhole and to slide within the slot. A threaded fastener post extends from the bolthead and a nut that threads onto the threaded fastener post. A clamp is attachable to the rail. The clamp includes an arm portion with a bore disposed therethrough for receiving the threaded fastener post, a hook extending from the arm portion for engaging a corresponding hook on the rail, a first clamp flange positioned above the hook and engageable with a first portion of the rail, a second clamp flange extending from the hook transverse to the first clamp flange and engageable with a second portion of the rail. Engagement of the first clamp flange with the first portion of the rail and the second clamp flange with the second portion of the rail prevent the clamp from falling off the rail during installation.

### RELATED APPLICATIONS

The present Application relates to and claims priority to U.S. Provisional Patent Application, Ser. No. 63/700180, filed on Sep. 27, 2024, entitled “Tonneau Cover Holddown System.” The subject matter disclosed in that Provisional Application is hereby expressly incorporated into the past Application.

### TECHNICAL FIELD AND SUMMARY

The present disclosure relates to trucks, such as pickup trucks, and truck beds or cargo boxes used on pickup trucks and like vehicles. In particular, the present disclosure relates to a truck bed cover, also known as a tonneau cover that includes new structural features that secure such cover onto the cargo box.

Tonneau or truck bed covers provide a covering for a truck bed or cargo box when used in combination with its sidewalls and tailgate. Covering the bed of a pickup truck helps create a secure compartment where items may be stored out of view when the tailgate is in an upward and latched position. Embodiments of a tonneau cover may include a cover portion that is suspended over the truck bed between the sidewalls. A frame or rail assembly may be employed that attaches to the opposing sidewalls to secure the cover onto the cargo box.

Tonneau covers can also include a bulkhead panel. A bulkhead panel is the forwardmost panel of the tonneau cover located at the front end of the cargo box directly behind the cab section. The bulkhead panel can be secured to the rail assembly attached to the cargo box. Tonneau covers can include one or more folding or rolling panels that move with respect to the bulkhead panel between open and closed positions. In contrast, the bulkhead panel is intended to secure the tonneau cover to the rails, while allowing one or more folding covers to move relative to the bulkhead panel. Accordingly, the bulkhead panel needs to secure independently to the rail assembly to keep the tonneau cover secured to the cargo box.

Accordingly, an illustrative embodiment of the present disclosure provides a tonneau cover holddown assembly for securing a bulkhead panel of a tonneau cover to a rail positioned on a sidewall of a cargo box of a truck. The tonneau cover holddown assembly includes a pocket assembly disposed through an underside surface of the bulkhead panel. The pocket assembly includes a channel extending therein. An end cap is attached to the pocket assembly. The end cap includes a keyhole in communication with the channel. A bolt assembly having a bolt with a slider coupled thereto. The slider is sized to fit through the keyhole and slide within the channel. The bolt also includes a threaded fastener post extending from the slider. A nut threads onto the threaded fastener post.

The tonneau cover holddown assembly also includes a clamp attachable to the rail. The clamp includes an arm portion with a bore disposed therethrough for receiving the threaded fastener post; a hook extends from the arm portion for engaging a corresponding hook on the rail; a first clamp flange positioned above the hook, extendable from the arm portion, and engageable with a first portion of the rail; a second clamp flange extending from the hook transverse to the first clamp flange, and engageable with a second portion of the rail; and when the hook engages the corresponding hook on the rail engagement of the first clamp flange with the first portion of the rail and the second clamp flange with the second portion of the rail prevent the clamp from falling off the rail during installation. When the nut is tightened onto the threaded fastener post, the clamp is drawn toward the pocket assembly to further tighten the hook onto the corresponding hook of the rail to secure the bulkhead panel to the rail. The pocket assembly includes one or more relief tabs that extend from the pocket assembly and are supported by a side frame of the bulkhead panel.

In the above and other illustrative embodiments, the tonneau cover holddown assembly may further comprise: a holddown clamp locator disposed adjacent the pocket assembly, attached to the rail, and configured to longitudinally align the clamp on the rail; the holddown clamp locator includes a first abutment that restricts a position of the clamp to a predetermined location on the rail; the holddown clamp locator includes a second abutment spaced apart from the first abutment, wherein the clamp can be positioned between the first abutment and the second abutment to locate the clamp in the predetermined location on the rail to prevent the clamp from sliding along the rail; a second holddown assembly positioned on an opposite side of the bulkhead panel from the tonneau cover holddown assembly, wherein the second holddown assembly secures the bulkhead panel to a second rail on an opposing sidewall of the cargo box; the nut being a flower nut configured with radially extending gripping lobes to facilitate manual tightening of the clamp; a wing nut located on the threaded fastener post to tightened against the nut.

Another illustrative embodiment of the present disclosure provides a tonneau cover holddown assembly for securing a bulkhead panel of a tonneau cover to a rail positioned on a sidewall of a cargo box of a truck. The tonneau cover holddown assembly includes a pocket assembly disposed through an underside surface of the bulkhead panel. The pocket assembly includes a channel extending therein. An end cap is attached to the pocket assembly and has a keyhole in communication with the channel. A bolt assembly that includes: a bolt with a head; the head sized to fit through the keyhole and slide within the channel; the bolt having a threaded fastener post that extends from the head; wherein the head is wider than the threaded fastener post; and a nut threaded onto the threaded fastener post. A clamp is attachable to the rail. The clamp includes: an arm portion with a bore disposed therethrough for receiving the threaded fastener post and a hook extending from the arm portion for engaging a corresponding hook on the rail.

In the above and other illustrative embodiments, the tonneau cover holddown assembly may further comprise: the clamp further including a first clamp flange positioned above the hook, extendable from the arm portion, and engageable with a first portion of the rail, and a second clamp flange extending from the hook transverse to the first clamp flange and engageable with a second portion of the rail; when the hook engages the corresponding hook on the rail engagement of the first clamp flange with the first portion of the rail and the second clamp flange with the second portion of the rail prevent the clamp from falling off the rail during installation; when the nut is tightened onto the threaded fastener post, the clamp is drawn toward the pocket assembly to further tighten the hook onto the corresponding hook of the rail to secure the bulkhead panel to the rail; the bolt assembly includes a slider coupled thereto, wherein the slider is sized to fit through the keyhole and slide within the channel; the pocket assembly includes one or more relief tabs that extend from the pocket assembly and are supported by a side frame of the bulkhead panel; a holddown clamp locator disposed adjacent the pocket assembly, attached to the rail, and configured to longitudinally align the clamp on the rail; the holddown clamp locator includes a first abutment that restricts a position of the clamp to a predetermined location on the rail; the holddown clamp locator includes a second abutment spaced apart from the first abutment, wherein the clamp can be positioned between the first abutment and the second abutment to locate the clamp in the predetermined location on the rail and prevent the clamp from sliding along the rail; a second tonneau cover holddown assembly positioned on an opposite side of the bulkhead panel from the tonneau cover holddown assembly, and wherein the second tonneau cover holddown assembly secures the bulkhead panel to a second rail on an opposing sidewall of the cargo box.

Another illustrative embodiment of the present disclosure provides a tonneau cover holddown assembly for securing a bulkhead panel of a tonneau cover to a rail positioned on a sidewall of a cargo box of a truck. The tonneau cover holddown assembly includes: a slot disposed through an underside surface of the bulkhead panel, the slot including a keyhole in communication with the slot. A bolt including a bolthead is sized to fit through the keyhole and to slide within the slot. The bolthead is wider than the slot; and a threaded fastener post extends from the bolthead and a nut threads onto the threaded fastener post. A clamp attachable to the rail. The clamp includes an arm portion with a bore disposed therethrough for receiving the threaded fastener post, a hook extending from the arm portion for engaging a corresponding hook on the rail, a first clamp flange positioned above the hook and engageable with a first portion of the rail, a second clamp flange extending from the hook transverse to the first clamp flange and engageable with a second portion of the rail, and when the hook engages the corresponding hook on the rail, engagement of the first clamp flange with the first portion of the rail and the second clamp flange with the second portion of the rail prevent the clamp from falling off the rail during installation. When the nut is tightened onto the threaded fastener post, the clamp is drawn toward the slot to further tighten the hook onto the corresponding hook on the rail to secure the bulkhead panel to the rail.

In the above and other illustrative embodiments, the tonneau cover holddown assembly may further comprise: a pocket assembly disposed within the slot and configured to receive the bolthead; and the pocket assembly comprises one or more relief tabs configured to transfer clamping forces from the clamp to a side frame of the bulkhead panel.

Additional features and advantages of the tonneau cover holddown system will become apparent to those skilled in the art upon consideration of the following detailed descriptions of carrying out the tonneau cover holddown system as presently perceived.

### BRIEF DESCRIPTION OF THE DRAWINGS

The present disclosure will be described hereafter with reference to the attached drawings which are given as non-limiting examples only, in which:

FIG. 1 is a rear perspective view of a pickup truck and accompanying truck bed or cargo box with a tonneau cover located thereon;

FIG. 2 is another perspective view of the pickup truck and accompanying cargo box with a toneau cover located thereon and one panel section folded over onto another panel section and a partially raised position;

FIG. 3 is another perspective view of the pickup truck and accompanying cargo box with a tonneau cover located thereon and two panel sections folded to a raised position;

FIG. 4 is another perspective view of the pickup truck and accompanying cargo box with a tonneau cover located thereon and two panel sections folded over onto a third panel section;

FIG. 5 is another perspective view of the pickup truck and accompanying cargo box with a tonneau cover located thereon and all four panel sections folded to a raised position;

FIG. 6A is a perspective isolated progression view of the toneau cover and rails with the tonneau cover in a full closed position;

FIG. 6B is another perspective isolated progression view of the toneau cover and rails with the tonneau cover having one panel section folded over onto a second panel section;

FIG. 6C is another perspective isolated progression view of the toneau cover and rails with the tonneau cover having two panel sections folded over onto a third panel section;

FIG. 6D is another perspective isolated progression view of the toneau cover and rails with the tonneau cover having three panel sections folded over onto a fourth panel section;

FIG. 6E is another perspective isolated progression view of the toneau cover and rails with the tonneau cover having all of the panel sections raised to an upright position;

FIG. 7 is an underside detail view of a bulkhead panel of the tonneau cover seated on a rail;

FIG. 8 is an exploded detail perspective view of the underside of the bulkhead panel and including a toneau cover holddown assembly;

FIG. 9 is a forward facing cross-sectional view of a portion of the bulkhead panel of the toneau cover and rail;

FIG. 10 is a perspective detail view of a portion of the rail with a clamp located adjacent a holddown clamp locator;

FIG. 11 is another perspective detail view of a portion of the rail with a clamp located adjacent a holddown clamp locator;

FIG. 12 is a perspective detail view of a portion of the tonneau cover, rail, and holddown clamp;

FIG. 13 is a perspective sectional detail view of the holddown clamp positioned on the rail;

FIG. 14 is an isolated side detail view of the holddown clamp fitted in the rail;

FIG. 15 is another isolated side detail view of the holddown clamp fitted in the rail;

FIG. 16 is an isolated perspective view of the toneau cover holddown assembly position within the holddown clamp locator;

FIG. 17 is an isolated perspective view of a pocket and end cap located thereon;

FIG. 18 is a perspective detail view of a portion of the bulkhead panel secured to the rail via the toneau cover holddown assembly;

FIG. 19 is an underside partially exploded detail view of a portion of the bulkhead panel and rail;

FIG. 20 is an underside detail perspective view of a portion of the rail, bulkhead panel, and tonneau cover holddown assembly;

FIG. 21 is a partially exploded underside detail view of a portion of the rail, bulkhead panel, and the cover holddown assembly;

FIG. 22 is a detail underside perspective view of the rail and bulkhead panel;

FIG. 23 is another detail underside perspective view of the rail and bulkhead panel; and

FIG. 24 is a another detail underside perspective view of the rail and bulkhead panel.

Corresponding reference characters indicate corresponding parts throughout the several views. The exemplification set out herein illustrates embodiments of the tonneau cover holddown system, and such exemplification is not to be construed as limiting the scope of the tonneau cover holddown system in any manner.

### DETAILED DESCRIPTION OF THE DRAWINGS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

An illustrative embodiment of the present disclosure provides a tonneau cover holddown assembly. The illustrative embodiment of the tonneau cover holddown assembly includes a clamp that is held on a rail during assembly and installation of the tonneau cover. As positive placement at a predetermined location on the rail, a pocket assembly is located on the underside of the bulkhead panel to hold a bolt assembly that secures the clamp to the pocket assembly and the rail. This, therefore, secures the bulkhead panel to the rail. An illustrative embodiment of the clamp includes an arm portion with a bore disposed therethrough, configured to receive the bolt assembly. Extending from the arm portion is a hook that engages a corresponding hook on the rail with a laterally extending flange positioned above the hook and engages a separate portion of the rail, such as the catch portion. A downwardly directed flange is engageable with a lower portion of the rails, such as a lower channel. The laterally extending flange and downwardly directed flange assist in holding the clamp on to the rail, albeit loosely, while installing the tonneau cover. In other words, the clamp does not fall off the rail while the tonneau cover is being attached to the cargo box.

The bolt assembly, illustratively, includes a bolt with a bolthead that is positionable within a channel disposed in the clamp pocket assembly and extends through the bore of the clamp arm. A slider may be placed adjacent to or surround the bolthead to assist sliding along the channel of the clamp pocket assembly during the tonneau cover's installation. The clamp's hook, laterally extending flange portion, and downwardly extending flange portion are configured to allow horizontal insertion of the clamp into the rail with the laterally extending flange portion and downwardly extending flange portion preventing the clamp from rotating or otherwise falling out of the rail during this installation process.

An illustrative embodiment of the clamp pocket assembly may include a pocket structure which houses the channel within which the bulkhead and slider fit in order to position the clamp on the rail. One or more relief tabs extend from the pocket. When the bolt is tightened onto the clamp and rail for securing the bulkhead panel to the rail, the relief tabs are fitted within a side frame of the bulkhead panel. This side frame supports the relief tabs as well, and as a portion of the bulkhead panel, while, illustratively, being supported by the top of the rail or top side wall of the cargo box. With this configuration, the clamping forces created by the bolt assembly and clamp can be distributed from the relief tabs to the side frame of the bulkhead panel and sidewall of the cargo box to provide secure attachment of the bulkhead panel to the cargo box. It is appreciated that this tonneau cover holddown assembly can be located on each side of the bulkhead panel for purposes of attaching same to both opposing sidewalls of the cargo box.

The clamp pocket assembly may further include an end cap that can be secured to the pocket extrusion by means of adhesives, fasteners, or rivets, for example. The end cap may include a key opening configured to be wider than a slot located in the periphery of the channel to receive the fastener post portion of the bolt. The key opening is configured to receive the slider with the bolthead to allow same to fit within the channel of the pocket and slide along same. It is appreciated that the end cap may be riveted through openings in both the end cap and a portion of the pocket.

In another illustrative embodiment of the present disclosure, a holddown clamp locator is attachable to the rail to provide positive stop locations for the clamp along the rail. The clamp locator can also assist providing a predetermined placement location for the clamp. This can be useful for easier installation when installing the cover on the cargo box. One or more abutments can be employed on the clamp locator to position the clamp in the predetermined location. Illustratively, a second abutment can be employed and the clamp positioned between the two abutments, not only to locate the clamp in its predetermined location on the rail, but also prevent the clamp from sliding along the rail under circumstances where a longitudinal force is applied, such as the pickup truck stopping or starting suddenly. In other words, if the truck accelerates or decelerates suddenly the clamp, and therefore, the tonneau cover will not shift back or forth over the cargo box. Illustratively, to secure the bolt assembly and clamp onto the bulkhead panel and, thereby, the cargo box, a flower nut is threaded onto the fastener post. A wingnut may be used as well, positioning adjacent the flower nut for purposes of securing same onto the bolt.

Another illustrative embodiment of the present disclosure provides a tonneau cover holddown assembly similar to that described above, except that the clamp pocket assembly is replaced with a keyhole and slot disposed through a portion of the underside of the bulkhead panel assembly. In this embodiment, the pocket assembly and bolthead slider may be removed and the bolthead itself positionable in the keyhole so the threaded bolt portion is slidable along the slot. The remainder of the tonneau cover holddown assembly can remain the same and clamp the bulkhead panel to the rail.

Another illustrative embodiment of the present disclosure also provides a tonneau cover holddown assembly. Again, this embodiment is similar to the original embodiment, including a pocket and end cap assembly. The clamp may also be the same. A distinction from the other embodiments is that the end cap may be configured to have a keyhole that is sized to receive the bolthead, but not the bolthead slider. The bolthead may fit through the end cap and slide along the channel like the prior embodiment and secure the clamp to the rail. As previously described, this embodiment, as well as the others, may or may not include the clamp locator.

Exemplary subject matter related to a variety of tonneau covers configurable to employing the various embodiments of the tonneau cover down assembly are disclosed in U.S. Pat. Nos. 10,800,234, entitled “Folding Cover Attachment Systems,” issued on Oct. 13, 2020, as well as U.S. Pat. No. 11,299,021, entitled “Multi-Panel Tonneau Cover,” issued on Apr. 12, 2022, which are hereby expressly incorporated into this present Application in their entireties.

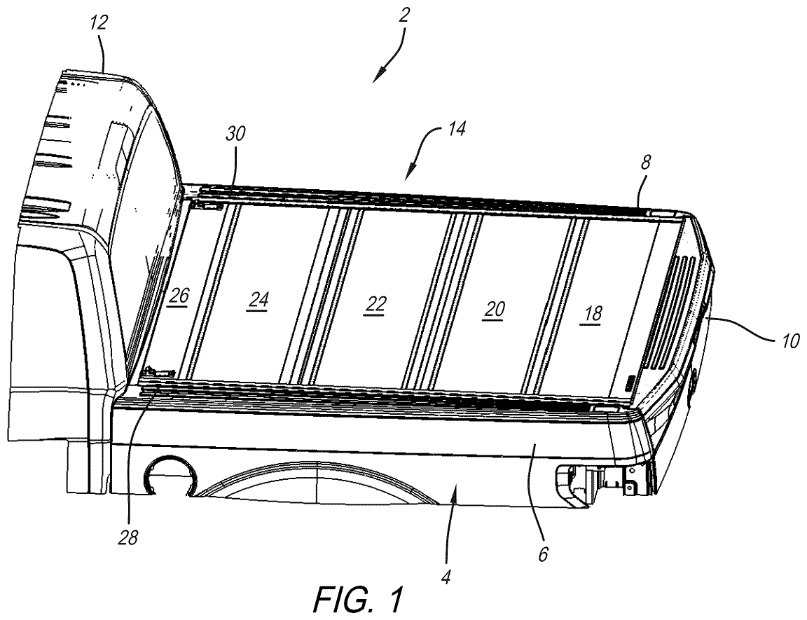

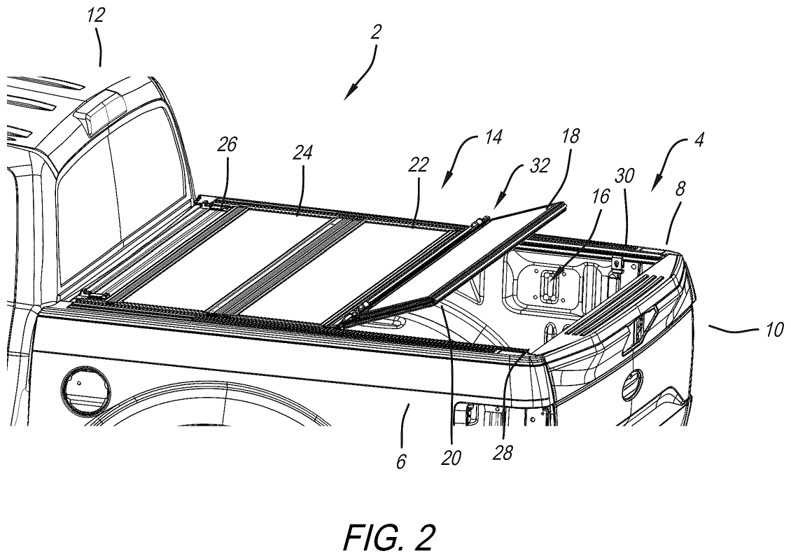

A rear perspective view of a truck 2, with an accompanying truck bed 4 comprising sidewalls 6 and 8, is shown in FIG. 1. This view also depicts tailgate 10 and cab section 12 located opposite each other with truck bed 4 located therebetween. Illustratively, a tonneau cover 14 is shown shrouding interior 16 of cargo box or truck bed 4 (see, also, FIG. 2). Tonneau cover 14 is composed of a plurality of panel sections 18, 20, 22, and 24 that are pivotably attached to each other as shown (see, also, FIGS. 2, 3, and 4). A bulkhead panel assembly 26 is secured to rails 28 and 30, which are positioned along the inner periphery of sidewalls 6 and 8, respectively. Illustratively, panel section 18 is pivotably attached to bulkhead panel assembly 26. It is appreciated that the tonneau cover 14 shown herein is illustrative.

Another perspective view of truck 2 is shown in FIG. 2. In this view, tonneau cover 14 is depicted partially shrouding truck bed 4. In particular, panel section 18 is folded over panel section 20. In addition, panel section 20 is pivoted with respect to panel section 22. By folding at least one of the panel sections, interior 16 of truck bed 4 becomes accessible. Latching assembly 32 is shown on panel section 18. It is contemplated that latching assembly 32 will engage rails 28 and 30 to latch thereto when all of panel sections 18, 20, 22, and 24 of tonneau cover 14 are laid flat covering truck bed 4 and shrouding interior 16. Because latching assembly 32 is directed towards interior 16 of truck bed 4, such latches are concealed from the exterior of truck 2. Additionally, it is appreciated that latching assembly 32 need not be employed on the underside of every panel section.

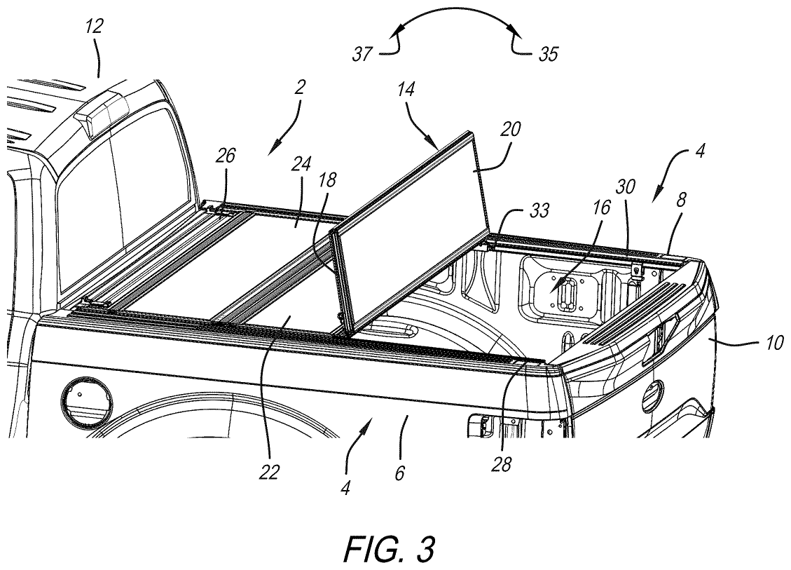

Another perspective view of truck 2 is shown in FIG. 3. Similar to the views shown in FIGS. 1 and 2, truck 2 depicts tonneau cover 14 laying atop sidewalls 6 and 8 via rails 28 and 30 to shroud a portion of interior 16 of truck bed 4. This view, however, also shows panel sections 18 and 20 of tonneau cover 14 folded over further than that shown in FIG. 2 to further reveal interior 16 underneath. Also shown in this view is a mechanical catch assembly 33 attached to rail 30 and bulkhead panel assembly 26.

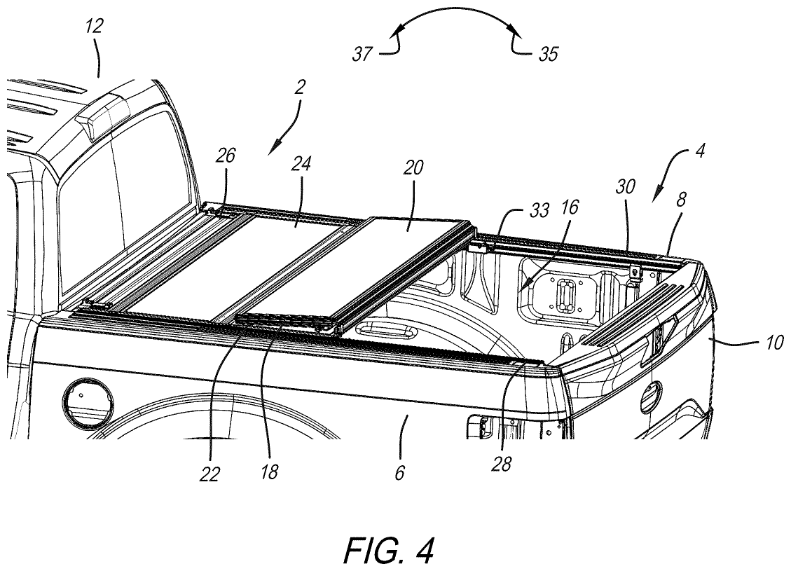

A similar perspective view of truck 2, as shown in FIGS. 1, 2, and 3, is also shown in FIG. 4. This view differs from FIGS. 1, 2, and 3 in that panel sections 18 and 20 are folded over onto panel section 22. Illustratively, panel sections 18 and 20 have been pivoted in direction 37 toward bulkhead panel assembly 26.

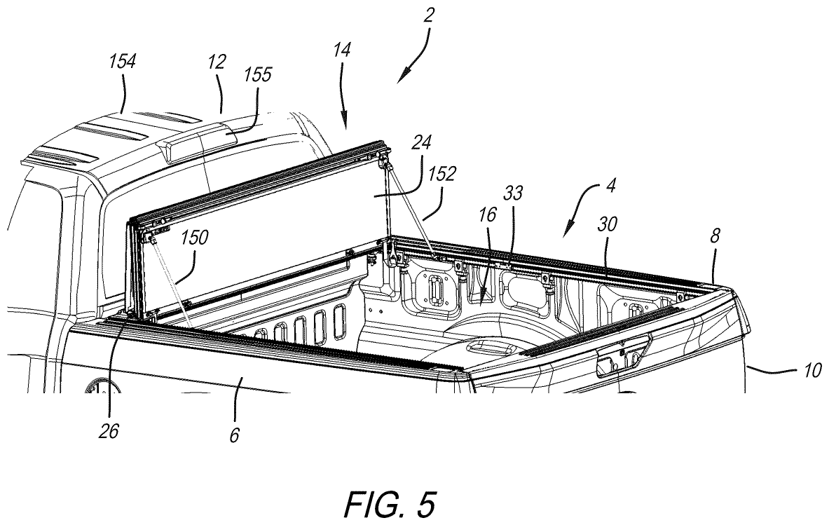

A similar perspective view of truck 2, as shown in FIGS. 1, 2, 3, and 4, is also shown in FIG. 5. This view differs from the others in that panel sections 18, 20, 22, and 24 are folded over and stacked vertically onto bulkhead panel assembly 26. Prop rods 150 and 152 are both coupled to panel section 24 and onto rails 28 and 30, respectively. The prop rods assist in keeping the stack of panel sections 18, 20, 22, and 24 upright while truck 2 is moving.

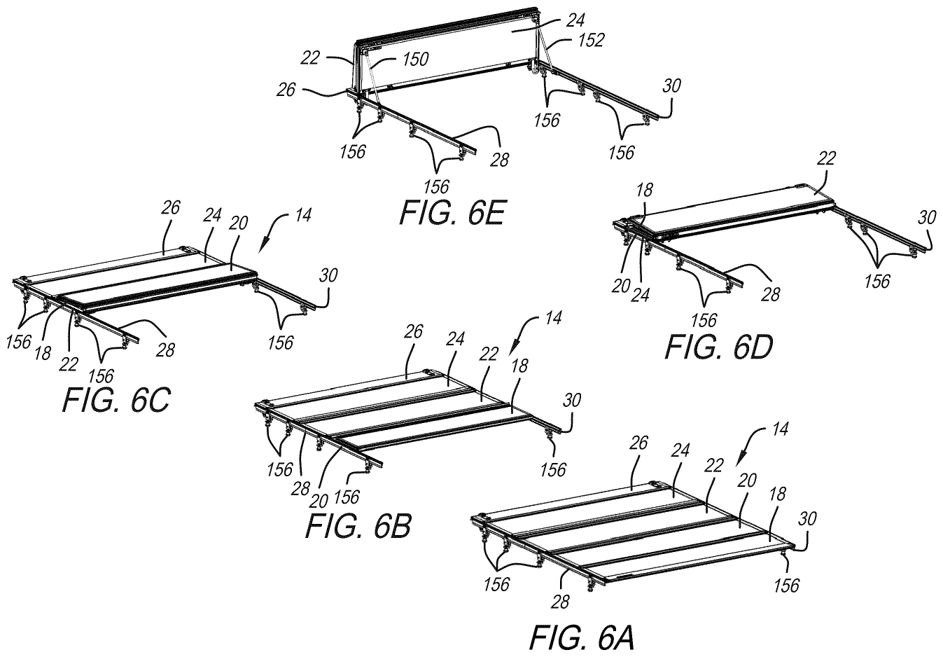

Perspective, isolated, progression views showing tonneau cover 14 on rails 28 and 30, with the tonneau cover being moved from a full closed position to a full open position, is shown in FIGS. 6A, 6B, 6C, 6D, and 6E. The view shown in FIG. 6A depicts tonneau cover 14 in its full closed position on rails 28 and 30. Here, as with the view shown in FIG. 1, tonneau cover 14 completely shrouds interior 16 of truck bed 4. As such, panel sections 18, 20, 22, and 24 are unfolded and lay on rails 28 to 30. Bulkhead panel assembly 26 is shown at the forward end of tonneau cover 14 adjacent panel section 24.

The view shown in FIG. 6B is the same as that of FIG. 6A, but with panel section 18 stacked on panel section 22 to begin opening tonneau cover 14, similar to that shown in FIG. 2. The folding of tonneau cover 14 continues in FIG. 6C where now both panel sections 18 and 20 are stacked onto panel section 22. By progressing with this stacked arrangement, it is appreciated that more of interior 16 of truck bed 4 will be exposed as further shown in FIGS. 4 and 5.

Further, stacking all of panel sections 18, 20, and 22 onto panel section 24 is shown in FIG. 6D. Lastly, as shown in FIG. 6E, the stack of panel sections 18, 20, 22, and 24 are pivoted upright onto bulkhead panel assembly 26, which supports the stack in its upright position. Prop rods 150 and 152 attach to both panel section 24 and onto rails 28 and 30, respectively, to maintain the stack of panel sections in this upright position while the truck is moving. Further shown in this and the other views are clamps 156 on both rails 28 and 30. Clamps 156 are configured to attach rails 28 and 30 to their adjacent sidewalls 6 and 8, respectively. It is appreciated that the number of panel sections is illustrative. More or less panel sections may employ the features disclosed herein.

Another illustrative embodiment of the present disclosure provides alternative tonneau cover holddown assemblies. These illustrative tonneau cover holddown assemblies include a clamp that is configured to hold onto the rail, such as rails 28 and 30, during assembly and installation of tonneau cover 14. It is appreciated that these tonneau cover holddown assemblies can also be employed with soft folding, soft rolling, and single panel tonneau covers that employ a bulkhead panel or bulkhead panel-type structure that these tonneau cover holddown assemblies disclosed herein can connect to. The configuration of the clamp, as disclosed herein, can be held onto the rail, albeit loosely, while installing the tonneau cover.

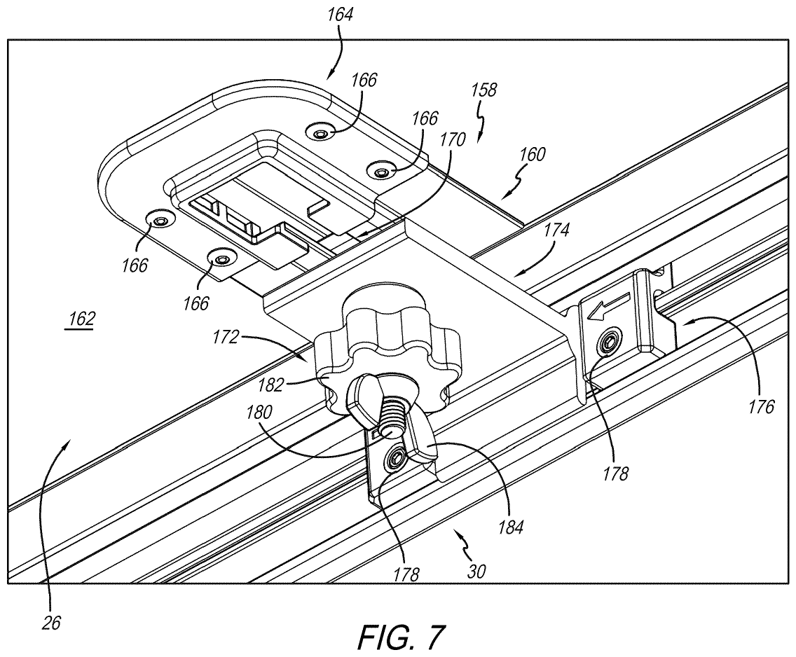

An underside detail view of bulkhead panel 26, of tonneau cover 14, seated on rail 30, is shown in FIG. 7. Tonneau cover holddown assembly 158 is configured to hold bulkhead panel 26 to rail 30, which, itself, is clamped to side wall 8 (see FIGS. 1-6 a-e). This translates to tonneau cover 14 securing to truck bed 4. Tonneau cover holddown assembly 158 includes a pocket 160 fitted into lower surface 162 of bulkhead panel 26. An end cap 164 is illustratively attached to pocket 160 and lower surface 162 via rivets 166. A keyhole 168 is disposed in end cap 164 and is in communication with a channel 170 formed within pocket 160. This allows a portion of bolt assembly 172 to secure clamp 174 to pocket 160. As shown, clamp 174 is secured to rail 30, illustratively, within a holddown clamp locator 176 secured to rail 30, via set screws 178. Holddown clamp locator 176 assists in positioning clamp 174 at a predetermined location on rail 30. This assists in installing tonneau cover 14 onto truck bed 4. Bolt assembly 172 is shown in this view, including a threaded fastener post 180 securing clamp 174 to pocket 160 via knob or flower nut 182 and wingnut 184. It is appreciated that these same structures can also be installed onto the other side of bulkhead panel 26 as well in order to secure tonneau cover 14 onto both sides of the cargo box.

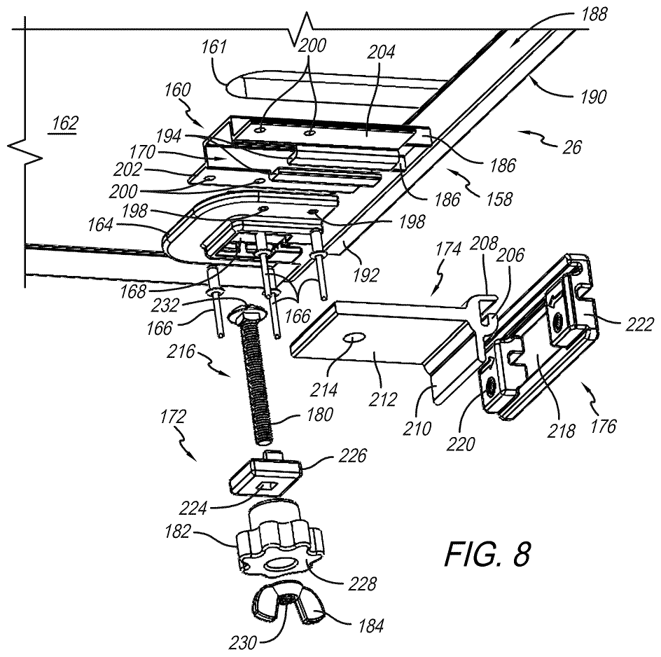

An exploded view of bulkhead panel 26, along with tonneau cover holddown assembly 158, is shown in FIG. 8. Here, pocket 160 is an illustrative extrusion that includes channel 170 extending therethrough. It is appreciated, however, that pocket 160 may be molded by known manufacturing methods. Pocket 160 can be fitted into slot 161 disposed through lower surface 162 of bulkhead panel 26. One or more relief tabs 186 are shown extending from the periphery of channel 170 and are configured to fit into frame channel 188 of frame member 190 located adjacent lower surface 162 of bulkhead panel 26. Relief tabs 186 are supported by lower wall 192 of frame member 190 in order to provide structural support for pocket 160. In particular, extending members 194 and 196 extend over channel 170 and provide a support surface for bolt assembly 172. When clamp 174 is drawn to pocket 160 via bolt assembly 172, at least a portion of the clamping forces generated by these structures can be supported through lower wall 192 with relief tabs 186 seated thereon. Such distribution of forces provides a stronger clamping connection between bulkhead panel 26 and rail 30.

End cap 164 includes rivet holes 198 disposed therethrough for purposes of receiving rivets 166. Illustratively, rivet holes 200 may be disposed through wing members 202 and 204 adjacent channel 170 of pocket 160 to receive rivets 166 as well. This view also shows clamp 174 with clamp hook 206 located between laterally extending flange portion 208 and downward directed clamp flange 210. These structures extend from clamp arm 212, which has a bore 214 disposed therethrough for receiving threaded fastener post 180 of bolt 216. Laterally extending flange portion 208 and downward directed clamp flange 210 serve to limit rotation of clamp 174 about the rail or otherwise fall out of the rail while clamping tonneau cover holddown assembly 158 to bulkhead panel 26 and the rail. In other words, clamp 174 can be placed onto a rail without falling from the rail (either rail 28 rail 30) prior to being secured to bulkhead panel 26.

Holddown clamp locator 176 is also shown. Opening 218 of holddown clamp locator 176 is sized to receive laterally extending flange portion 208, downward directed clamp flange 210, and clamp hook 206. Opening 218 does not interfere with the rail profile so that clamp 174 can sufficiently engage the rail (either rail 28 rail 30). However, abutments 220 and 222 define the lateral peripheries of opening 218 for purposes of positively positioning clamp 174 to a specific predetermined location on the rail. In addition, abutments 220 and 222 limit movement of clamp 174 longitudinally along the rail. By limiting this movement, clamp 174 is no longer free to slide up or down the rail. This means that if the pickup truck suddenly starts or stops, that sudden movement will not cause clamp 174 to move longitudinally with respect to the rail. This assists maintaining tonneau cover 14, particularly at bulkhead panel 26, onto cargo box or truck bed 4. Holddown clamp locator 176, therefore, aids in both assembling and securing tonneau cover 14 to cargo box or truck bed 4.

FIG. 8 further shows the several structures of bolt assembly 172. Fastener post 180 extends through a bore 224 of bolthead slider 226, as well as bores 228 and 230 of flower nut 182 and wingnut 184, respectively. Bolt 216 is extended through bore 214 of clamp 174 so that bolt assembly 172 can serve to clamp bulkhead panel 26 to rail 30. Bolthead slider 226 is fitted against bolthead 232 of bolt 216 and get sized to fit within keyhole 168 of end cap 164, as well as channel 170 of pocket 160. Bolthead slider 226 can, thus, slide within channel 170 along extending members 194 and 196.

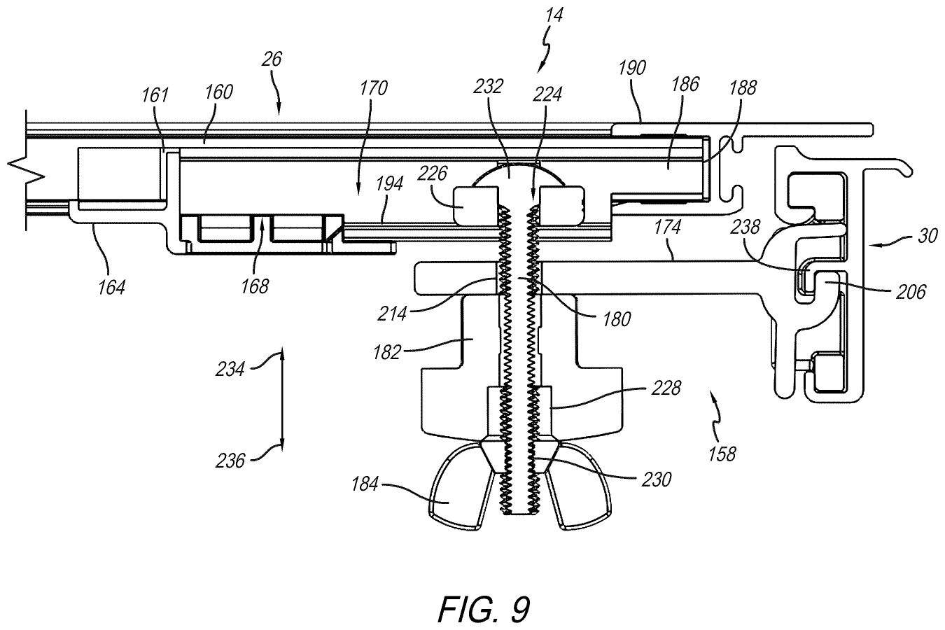

A forward facing cross sectional view of a portion of tonneau cover 14, particularly, bulkhead panel 26 and rail 30, is shown in FIG. 9. This view depicts tonneau cover holddown assembly 158 in a clamped condition securing bulkhead panel 26 (thus, tonneau cover 14) to rail 30. It is appreciated that an additional tonneau cover holddown assembly can be positioned opposite the one shown in this view further securing bulkhead panel 26 to rail 28. A separate tonneau cover holddown assembly 158 can be used on each side of bulkhead panel 26 to secure tonneau cover 14 to cargo box 4. In this view, pocket 160 is fitted in slot 161 within bulkhead panel 26. Relief tabs 186 are fitted within frame channel 188 of frame member 190. End cap 164 is also shown secured to pocket 160. Bolthead slider 226 has been inserted through keyhole 168 of end cap 164 and fitted within the channel 170 of pocket 160. In order to secure clamp 174 to rail 30, bolthead slider 226 sits on spaced apart extending member 194 (as well as extending member 196, not shown in this view). Bolthead 232 is fitted on bolthead slider 226 with threaded fastener post 180 extended through bore 224 and extending from pocket 160. Threaded fastener post 180 also extends through bore 214 of clamp 174, as well as threaded bores 228 and 230 of flower nut 182 and wingnut 184, respectively, as illustratively shown. By tightening flower nut 182 and wingnut 184 onto threaded fastener post 180 to move linearly in direction 234, clamp hook 206 is engageable with rail hook 238 of rail 30 coupling both together. This tightening of flower nut 182 and wingnut 184 also draws on bulkhead panel 26 in direction 236 to provide a clamping securement between rail 30 and bulkhead panel 26.

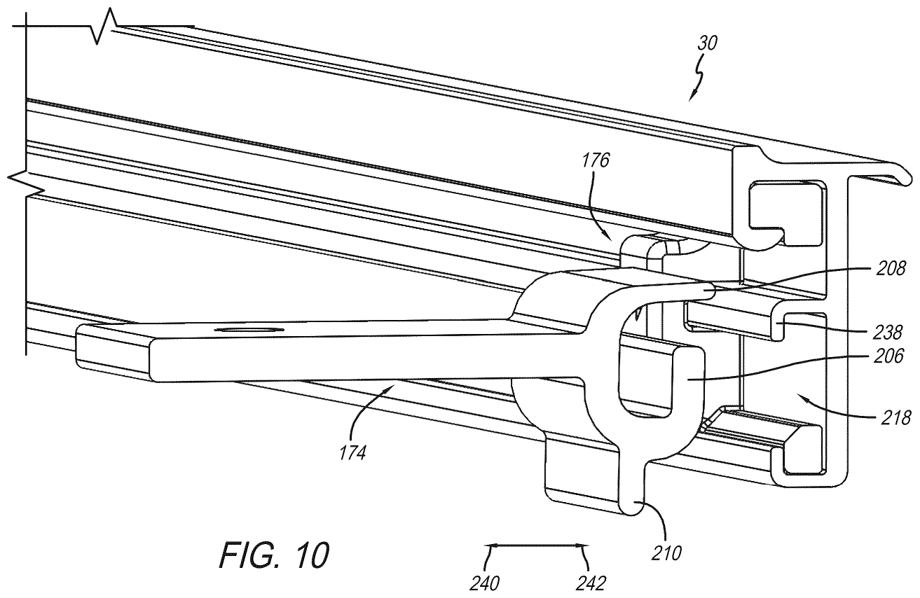

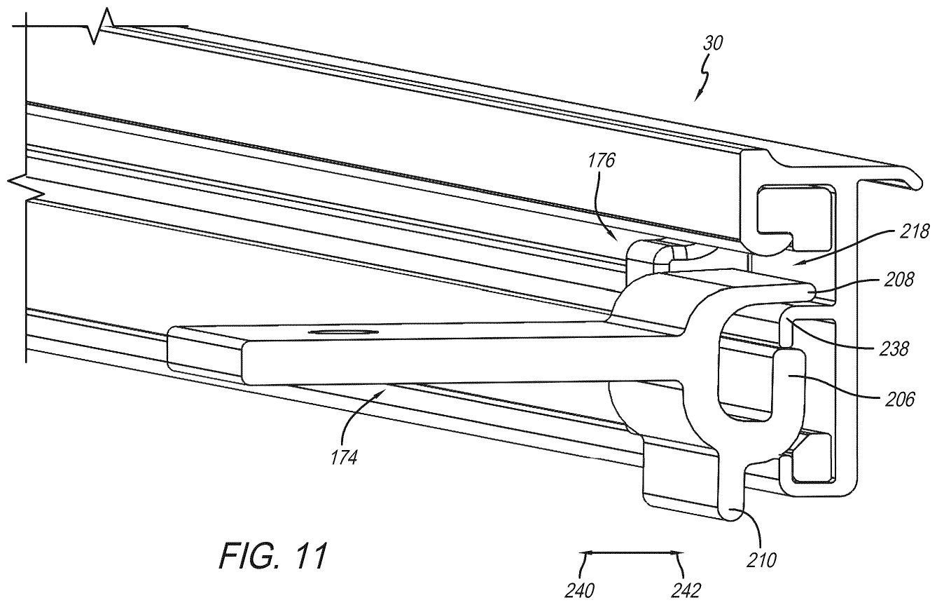

A perspective detail view of a portion of rail 30 with clamp 174 movable in directions 240 and 242, adjacent holddown clamp locator 176, is shown in FIG. 10. This view in FIG. 10 is part of a series of progression views of FIG. 10 through FIG. 13 demonstrating how clamp 174 fits onto rail 30. The views in FIGS. 10 and 11 demonstrate how clamp 174 is movable laterally in direction 242 towards rail 30. Here, laterally extending flange portion 208 positions above rail hook 238 of rail 30, whereas, clamp hook 206 is positioned below rail hook 238. It is appreciated from these views how hook 206, laterally extending flange portion 208, and downward directed clamp flange 210 are positioned about with an opening 218 of holddown clamp locator 176. It is also appreciated that this portion of the installation of tonneau cover 14 simply entails clamp 174 moving laterally towards the rail 30.

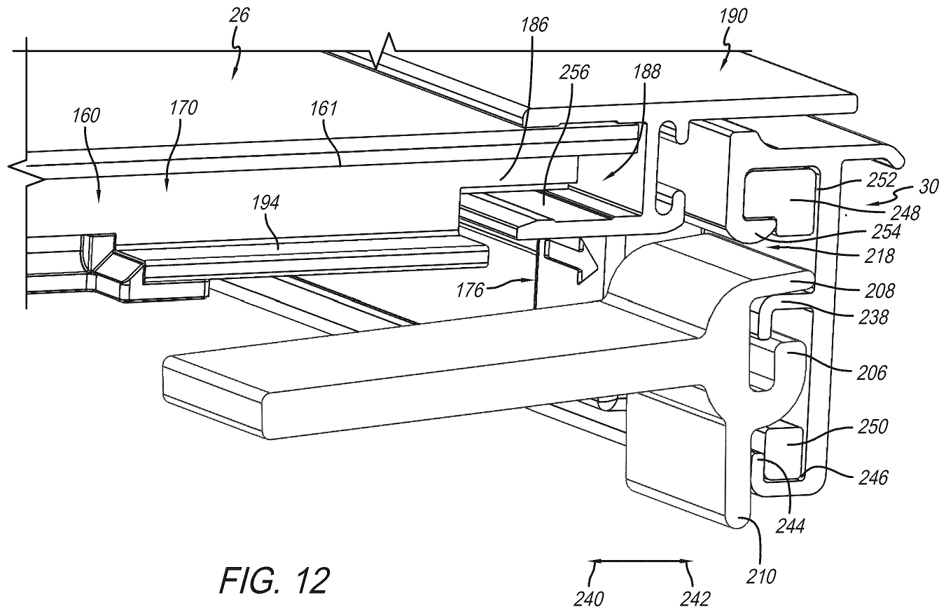

The view in FIG. 12 shows clamp 174 further moved in direction 242 from those views shown in FIGS. 10 and 11. In FIG. 12, laterally extending flange portion 208 sets above rail hook 238. While clamp hook 206 is positioned below rail hook 238. It is appreciated that clamp hook 206 is directed upward while rail hook 238 is directed downward so they can engage each other when tightening tonneau cover holddown assembly 158. This view also depicts a cross-sectional portion of bulkhead panel 26, including pocket 160 located within slot 161. Relief tab 186 is shown within frame channel 188 of frame member 190 of bulkhead panel 26. Because relief tab 186 sits on a base portion 256 as part of a periphery of frame channel 188, the clamping force created from tonneau cover holddown assembly 158 selectively attaching bulkhead panel 26 to rail 30 can be distributed to frame 190 and, thus, bulkhead panel 26.

Downward directed clamp flange 210 extending from clamp hook 206 is positioned exterior of rail 30 and opening 218 of holddown clamp locator 176. Downward directed clamp flange 210 may, illustratively, abut upturned edge 244 of lower rail channel 246. It is appreciated that a portion of top member 248 and bottom member 250 serve as a portion of the periphery of opening 218 and are fitted in rail 30 as part of holddown clamp locator 176. In particular, top member 248 may fit within upper channel 252 of rail 30 adjacent catch 254. Bottom member 250, in contrast, may fit within lower rail channel 246 adjacent upturned edge 244. At this point, however, clamp 174 is not yet secured to rail 30. Also shown is channel 170 disposed within pocket 160 and bounded at its lower end by extending member 194.

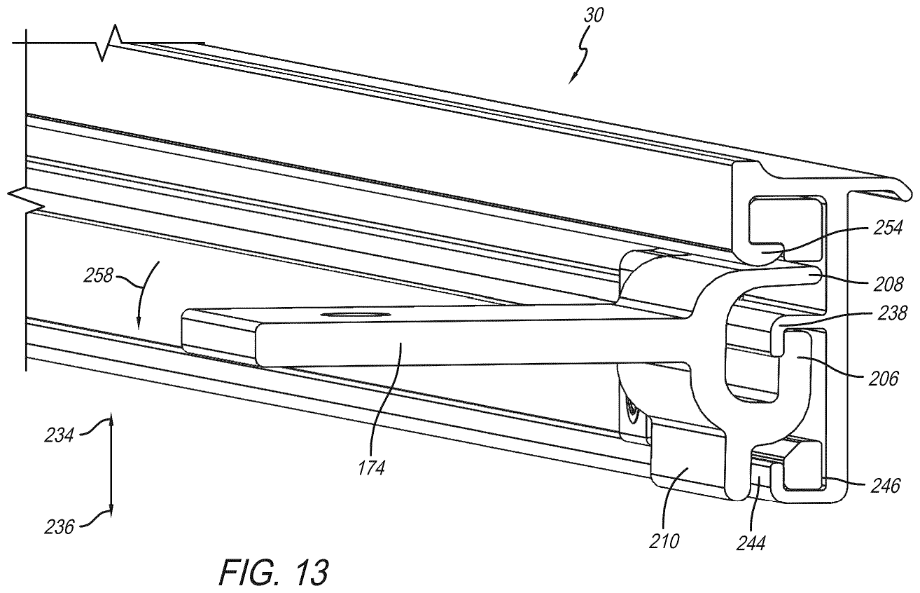

The perspective cross-sectional detail view of clamp 174 positioned on rail 30 is shown in FIG. 13. This view demonstrates a utility of clamp 174 with its laterally extending flange portion 208, clamp hook 206, and downward directed clamp flange 210. It is believed helpful that when installing cover holddown assembly 158 onto rail 30 (and/or rail 28), clamp 174 does not fall out of rail 30 prior to tightening. As described with respect to FIGS. 10-12, clamp 174 is moved laterally in direction 242 in order to engage rail 30, but that does not mean clamp 174 has been fully clamped onto rail 30. Bolt assembly 172 needs to be employed to move clamp 174 in direction 234 in order to facilitate the clamping process. Again, prior to that process, however, it will be helpful if clamp 174 does not fall out of rail 30. To accomplish this, laterally extending flange portion 208 may abut catch 254 while downturn directed clamp flange 210 can abut upturned edge 244 of lower rail channel 246. Also, clamp hook 206 may be engageable with rail hook 238. These cooperating structures prop up clamp 174 on rail 30. In essence, these structures limit clamp 174's ability to substantially rotate in direction 258, which otherwise could allow clamp 174 to pry out of rail 30 before the clamping operation. It is appreciated that either laterally extending flange portion 208 or clamp hook 206, or both, may engage the rail along with that downward directed clamp flange 210 to prop clamp 174 in place.

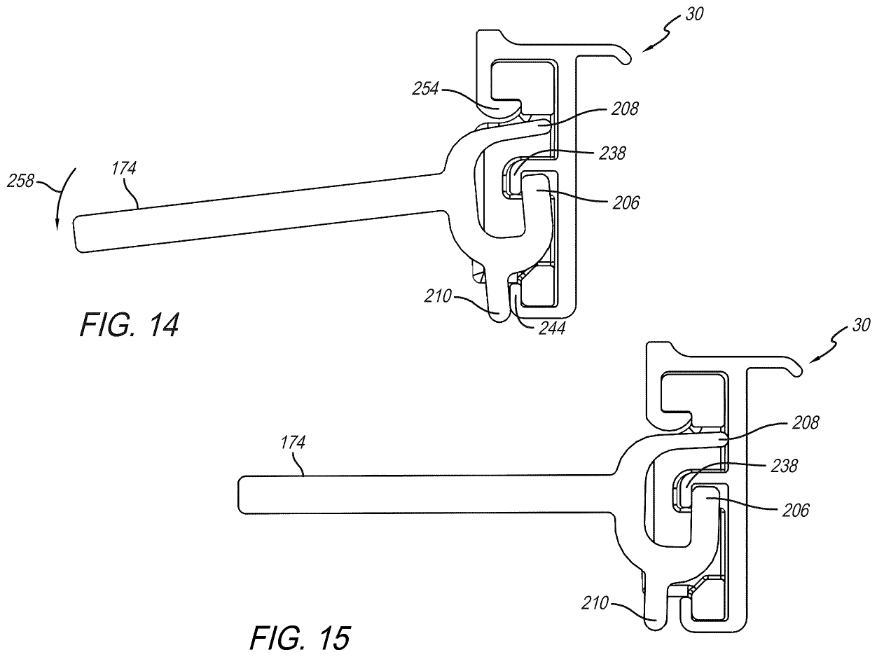

Side detail views of clamp 174 fitted in rail 30 are shown in FIGS. 14 and 15. The difference between the two views is that in FIG. 14, clamp 174 has not yet fully clamped onto clamp 30. Clamp 174 is only located or positioned onto rail 30. Nonetheless, and as shown, hook 206 engaging rail hook 238, along with downward directed clamp flange 210 abutting upturned edge 244, limit the extent to which clamp 174 can rotate in rotational direction 258 and otherwise pry or fall out of rail 30. In this view, clamp 174 is in a slightly raised position with respect to upturned edge 244 of rail 30. If clamp 174 was lower within rail 30, to the extent that hook 206 would not make sufficient contact with rail hook 238, then laterally extending flange portion 208 may abut catch 254 located above rail hook 238 in order to, again, limit rotational or downward movement of clamp 174 in order to hold the same within rail 30 prior to the clamping process.

The isolated sectional detail view of clamp 174 and rail 30, shown in FIG. 15, is similar to that shown in FIG. 14, except that clamp 174 is located in its clamped possession, typical after bolt assembly 172 has been tightened to secure clamp 174 to rail 30. As illustrated here, clamp hook 206 engages rail hook 238. Neither laterally extending flange portion 208 nor downward directed clamp flange 210 are needed to secure clamp 174 onto rail 30 once tonneau cover holddown assembly 158 is in its fully clamp condition.

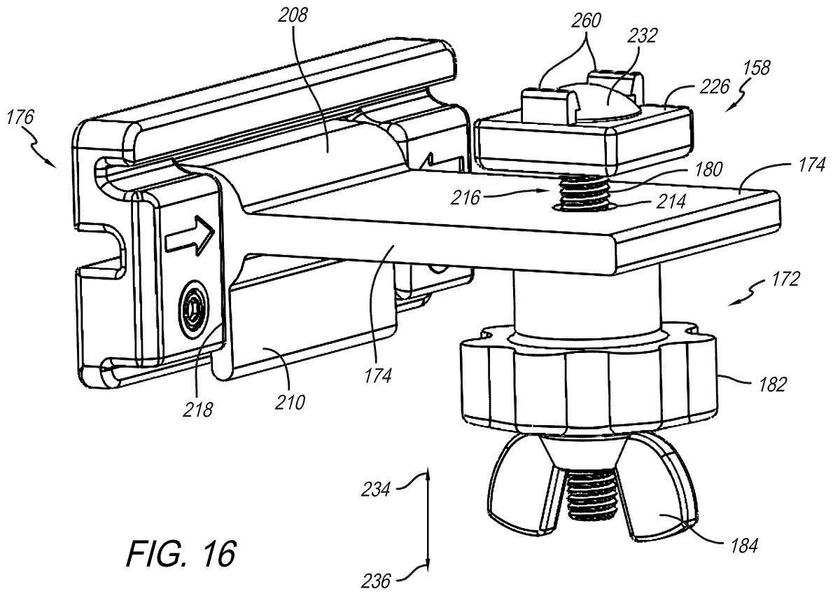

An isolated perspective view of tonneau cover holddown assembly 158 positioned within holddown clamp locator 176 is shown in FIG. 16. In addition to holddown clamp locator 176, clamp 174 and bolt assembly 172 are shown. Particularly, bolthead slider 226, illustratively, includes clips 260 extending therefrom and engageable with bolthead 232. Clips 260 assist holding bolthead 232 onto bolthead slider 226. Threaded fastener post 180 of bolt 216 is shown extending through bore 214 of clamp 174. Flower nut 182 and wingnut 184 are also shown threaded onto threaded fastener post 180. Illustratively, as flower nut 182 is threaded onto threaded fastener post 180 of bolt 216, clamp 174 is drawn upward in direction 234 to provide the clamping function on rail 30, as shown in FIGS. 8-15.

Wingnut 184 may be threaded onto threaded fastener post 180 for purposes of locking flower nut 182, thereby securing clamp 174 onto rail 30 (or rail 28 as the case may be). Also, demonstrated in FIG. 16 is how laterally extending flange portion 208, clamp hook 206 (not shown in this view), and downward directed clamp flange 210 are fitted in opening 218 of holddown clamp locator 176. It is appreciated from this view how opening 218 provides a predetermined indicator, which identifies the location with which clamp 174 should engage rail 30. This assists the installer to know the proper location for clamp 174. This eliminates the guesswork as to where rails 28 or 30 and clamps 174 are to be positioned. The installer simply places clamp 174 within opening 218 on a holddown clamp locator 176, positioned on each of rails 28 and 30, respectively. With clamp 174 positioned within opening 218 of holddown clamp locator 176, bulkhead panel 26 should be properly positioned on the cargo box or truck bed 4, thereby placing tonneau cover 14 in proper position over cargo box or truck bed 4 (see FIG. 1).

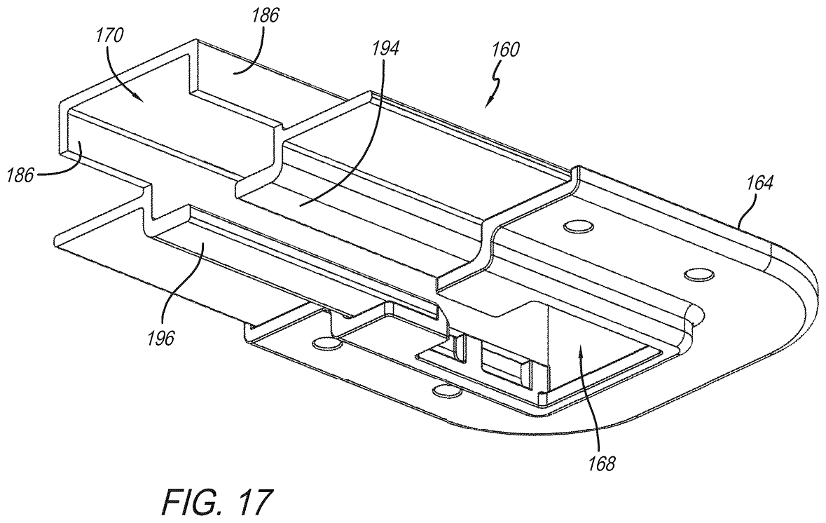

An isolated perspective view of pocket 160, with end cap 164 located thereon, is shown in FIG. 17. This view depicts channel 170 extending through pocket 160 adjacent relief tabs 186 located opposite end cap 164. Extending members 194 and 196 are shown adjacent relief tabs 186 and end cap 64 such that channel 170 extends through pocket 160 to keyhole 168 disposed through end cap 164. Keyhole 168 is sized to receive bolthead slider 226, which is positionable within channel 170. Extending members 194 and 196 narrow the lower periphery of channel 170 so that only the threaded fastener post 180 can fit through pocket 160. This allows extending members 194 and 196 to support bolthead slider 226 when coupled to clamp 174 for purposes of moving same towards rail 28 or 30.

Another illustrative embodiment of the present disclosure provides a tonneau cover holddown assembly that couples to a bulkhead panel for securing same to a railing. In this embodiment, however, rather than a series of structures, such as pocket 160 fitted into slot 161, and bounded by end cap 164, a keyhole and slot can be formed in the bottom surface of the bulkhead panel itself to accommodate and hold a bolthead of the fastening bolt used to secure the clamp to the rail. This results in fewer components (i.e., no longer need for pocket 160, end cap 164, bolthead slider 226, rivets 166, etc.). All that is needed is a milled or cut keyhole and slot disposed through the bottom member of the bulkhead panel.

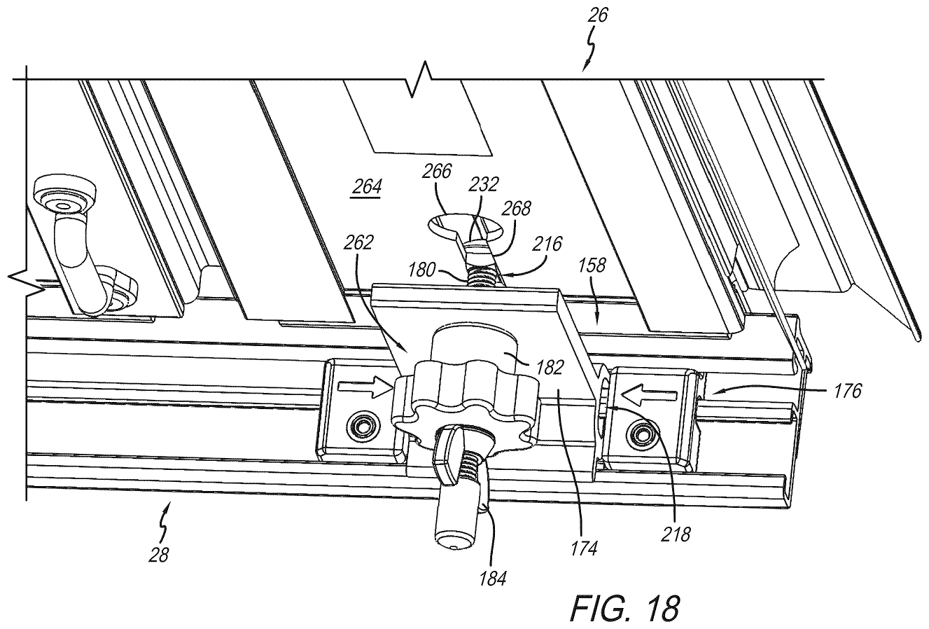

A perspective detail view of a portion of bulkhead panel 26 secured to rail 28 via tonneau cover holddown assembly 158 is shown in FIG. 18. Tonneau cover holddown assembly 158 is substantively similar to that shown in the prior embodiment except that bolt assembly 262, as shown, does not require any bolthead slider such as bolthead slider 226 of the prior embodiment. Like that shown in FIG. 18, bolthead slider 226 includes a bolt 216 having a bolthead 232 and a threaded fastener post 180 extending from bolthead 232. Flower nut 182 is threaded onto threaded fastening post 180, as is wingnut 184. Clamp 174, like the prior embodiment, fits into opening 218 of holddown clamp locator 176 to positively position clamp 174 along rail 28. The other structures with respect to rail 28, clamp 174, and holddown clamp locator 176 are the same as that discussed in the prior embodiment with respect to clamping onto the rail and being tightened to secure tonneau cover 14.

A distinction in this embodiment, as shown in this view, is a bottom panel or surface 264 of bulkhead panel 26, including a keyhole 266 and adjacent slot 268 positioned and sized to receive bolthead 232. Threaded fastener post 180 is movable along slot 268 to move clamp 174 towards rail 28 in the same manner previously described with the prior embodiment. Keyhole 266 and adjacent slot 268 may be milled or otherwise formed through the bottom member of bulkhead panel 26 as an alternative to slot 161, as shown in the prior embodiment.

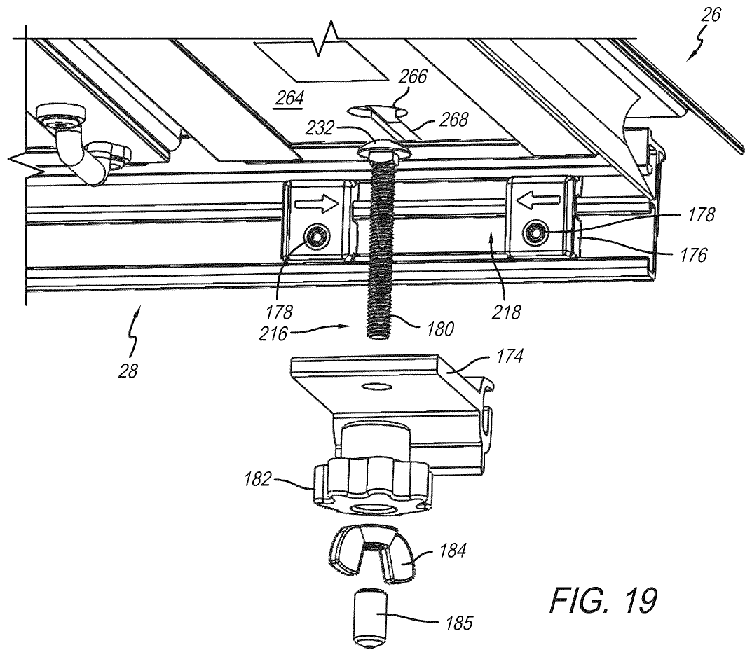

An underside partially exploded detail view of a portion of bulkhead panel 26 and rail 28 is shown in FIG. 19. Here, tonneau cover holddown assembly 158 is depicted in exploded view with clamp 174 and threaded fastener post 180 with bolthead 232 of bolt 216 located thereon. This view also includes flower nut 182, wingnut 184, and post cap 185 that can be secured onto threaded fastener post 180. Again, these structures are substantively similar to that shown in the prior embodiments. This view, however, also depicts keyhole 266 with adjacent slot 268 not only in communication with keyhole 266, but extending towards rail 28 on the underside panel or bottom surface 264 of bulkhead panel 26. This demonstrates that after inserting bolthead 232 through keyhole 266 and sliding bolt 216 along slot 268, clamp 174 can be moved to engage rail 28 as previously discussed in the prior embodiments. Again, this present embodiment demonstrates a potentially simpler design. Also shown in this view is holddown clamp locator 176 with opening 218 secured to rail 28 via sets crews 178.

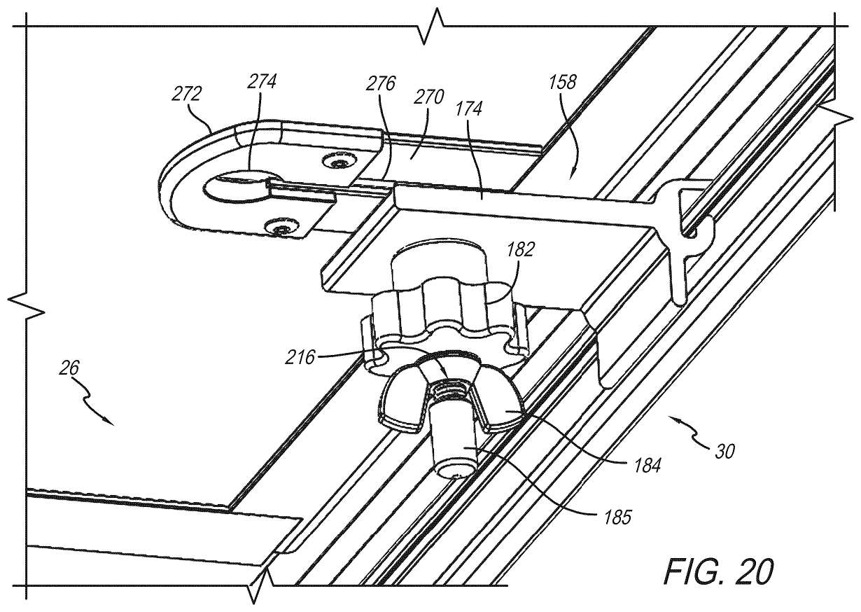

Another illustrative embodiment of the present disclosure provides a tonneau cover holddown assembly similar to the prior two embodiments. In this present embodiment, however, although a pocket and end cap are used similar to the first embodiment, a keyhole and slot is formed therein, shaped and sized to receive bolthead 232 and threaded fasting post 180 of bolt 216, without using bolthead slider 226. An underside detail perspective view of the portion of rail 30, along with bulkhead panel 26 and tonneau cover holddown assembly 158, is shown in FIG. 20. Here, bolt 216, clamp 174, flower nut 182, wingnut 184, and post cap 185 are similar to the prior two embodiments. The distinction is employing pocket 270 and end cap 272 that, collectively, form a keyhole 274 and adjacent slot 276 to receive bolt 216 without using bolthead slider 226.

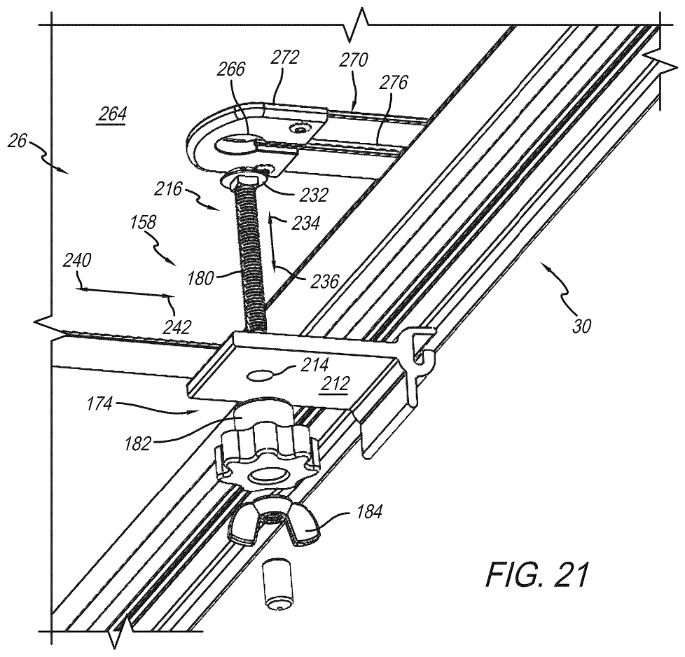

A partially exploded underside detail view of a portion of rail 30, bulkhead panel 26, and tonneau cover holddown assembly 158 is shown in FIG. 21. This view depicts pocket 270 fitted within bottom panel or surface 264 of bulkhead panel 26 along with endcap 272. Bolthead 232 of bolt 216 is movable upward in direction 234 and fitted into keyhole 266. Threaded fastener post 180 is extendable through bore 214 disposed through clamp arm 212 of clamp 174 in order to thread onto flower nut 182 and wingnut 184. Bolt 216 may then move laterally through slot 276 and pocket 270 in direction 242 for purposes of moving clamp 174 towards rail 30. Again, no bulkhead slider or like structure is employed in this embodiment.

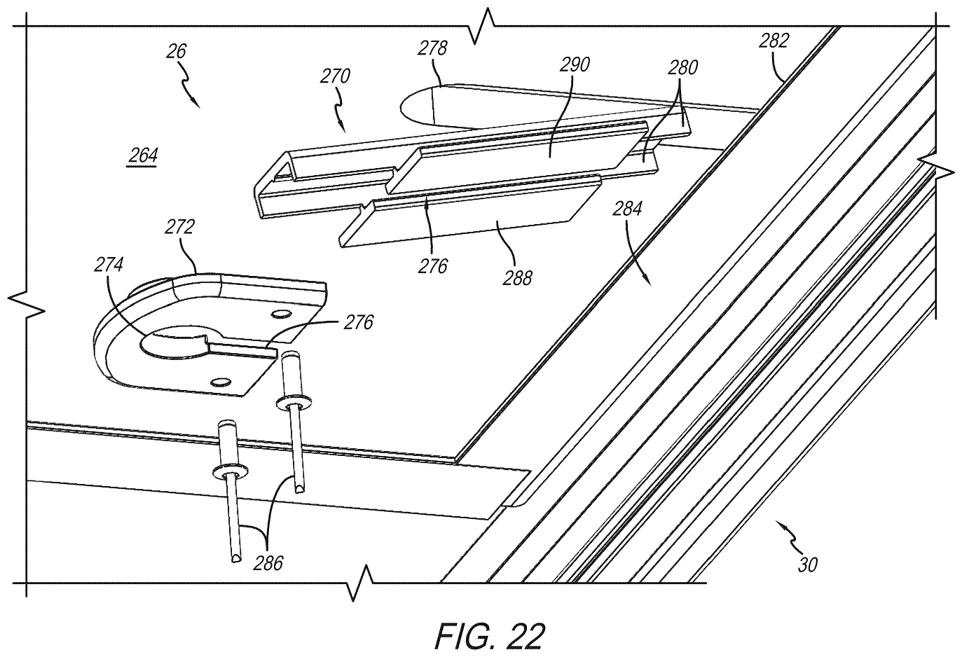

Detail perspective views of rail 30 and bulkhead panel 26 are shown in FIGS. 22, 23, and 24. These views demonstrate how pocket 270 and endcap 272 are assembled into slot 278, which is disposed through bottom panel or surface 264 of bulkhead panel 26. As shown in FIG. 22, pocket 270 is positionable within slot 278 in bulkhead panel 26. Like the previous embodiment, relief tabs 280 may extend from pocket 270 and engage base portion 282 of frame member 284 for supporting pocket 270 when clamped onto rail 30 (or rail 28 as the case may be). Endcap 272 with keyhole 274, as well as portion of the adjacent slot 276, is disposed through bottom panel or surface 264 of bulkhead panel 26. Endcap 272 is attachable to bulkhead panel 26 via rivets 286. It is appreciated that rivets 286 may be disposed through extending members 288 and 290 of pocket 270 or into bottom panel or surface 264 directly. It is appreciated that holddown clamp locator 176 may or may not be used in conjunction with clamp 174 for any of the embodiments disclosed herein.

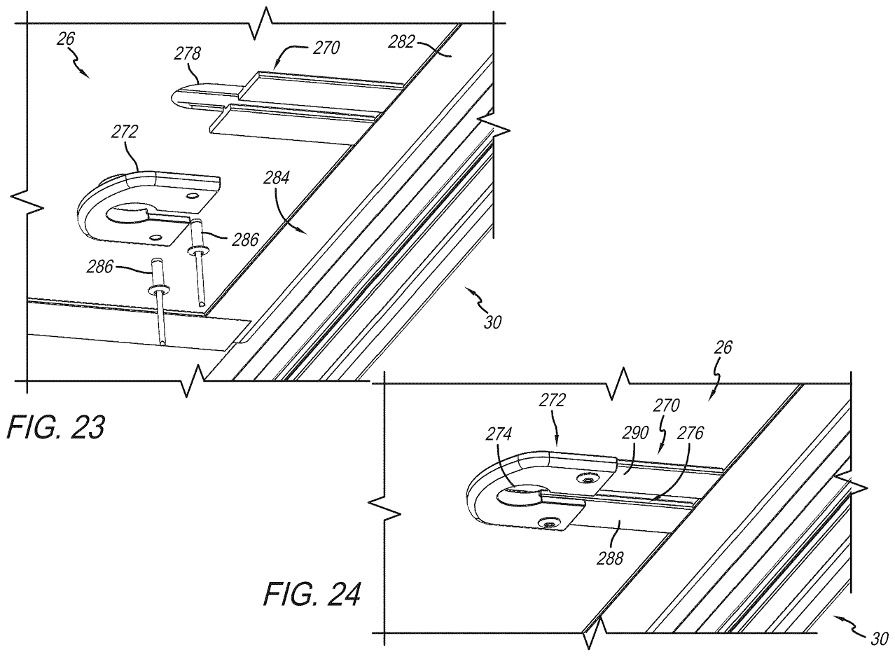

The underside detail perspective view of rail 30 and bulkhead panel 26, shown in FIG. 23, depicts pocket 270 positioned within slot 278. Relief tabs 280 (not shown in this view) are seated on base portion 282 of frame member 284. Endcap 272 is then able to attach to bulkhead panel 26 via rivets 286. Lastly, on the underside detail perspective view of rail 30 and bulkhead panel 26, endcap 272 is fastened onto extending members 288 and 290, respectively, of pocket 270. Keyhole 274 is shown in communication with slot 276 to receive bolthead 232 of bolt 216, as well as the ability to slide same towards rail 30 along slot 276.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that any subject matter disclosed in this non-provisional patent application that may differ from the priority application, the disclosure from this non-provisional patent application controls.

What is claimed

1. A tonneau cover holddown assembly for securing a bulkhead panel of a tonneau cover to a rail positioned on a sidewall of a cargo box of a truck, the tonneau cover holddown assembly comprising:
a pocket assembly disposed through an underside surface of the bulkhead panel;
wherein the pocket assembly includes a channel extending therein;
an end cap attached to the pocket assembly, the end cap having a keyhole in communication with the channel;
a bolt assembly that includes:
a bolt with a slider coupled thereto;
wherein the slider is sized to fit through the keyhole and slide within the channel;
wherein the bolt includes a threaded fastener post extending from the slider;
a nut threaded onto the threaded fastener post,
a clamp attachable to the rail, wherein the clamp includes:
an arm portion with a bore disposed therethrough for receiving the threaded fastener post,
a hook extending from the arm portion for engaging a corresponding hook on the rail,
a first clamp flange positioned above the hook, extendable from the arm portion, and engageable with a first portion of the rail,
a second clamp flange extending from the hook transverse to the first clamp flange, and engageable with a second portion of the rail,
wherein when the hook engages the corresponding hook on the rail engagement of the first clamp flange with the first portion of the rail and the second clamp flange with the second portion of the rail prevent the clamp from falling off the rail during installation;
wherein when the nut is tightened onto the threaded fastener post, the clamp is drawn toward the pocket assembly to further tighten the hook onto the corresponding hook of the rail to secure the bulkhead panel to the rail; and
wherein the pocket assembly includes one or more relief tabs that extend from the pocket assembly and are supported by a side frame of the bulkhead panel.

2. The tonneau cover holddown assembly of claim 1, further comprising a holddown clamp locator disposed adjacent the pocket assembly, attached to the rail, and configured to longitudinally align the clamp on the rail.

3. The tonneau cover holddown assembly of claim 2, wherein the holddown clamp locator includes a first abutment that restricts a position of the clamp to a predetermined location on the rail.

4. The tonneau cover holddown assembly of claim 3, wherein the holddown clamp locator includes a second abutment spaced apart from the first abutment, wherein the clamp can be positioned between the first abutment and the second abutment to locate the clamp in the predetermined location on the rail and prevent the clamp from sliding along the rail.

5. The tonneau cover holddown assembly of claim 1, further comprising a second holddown assembly positioned on an opposite side of the bulkhead panel from the tonneau cover holddown assembly, wherein the second holddown assembly secures the bulkhead panel to a second rail on an opposing sidewall of the cargo box.

6. The tonneau cover holddown assembly of claim 1, wherein the nut is a flower nut configured with radially extending gripping lobes to facilitate manual tightening of the clamp.

7. The tonneau cover holddown assembly of claim 1, further comprising a wing nut located on the threaded fastener post to tightened against the nut.

8. A tonneau cover holddown assembly for securing a bulkhead panel of a tonneau cover to a rail positioned on a sidewall of a cargo box of a truck, the tonneau cover holddown assembly comprising:
a pocket assembly disposed through an underside surface of the bulkhead panel;
wherein the pocket assembly includes a channel extending therein;
an end cap attached to the pocket assembly, the end cap having a keyhole in communication with the channel;
a bolt assembly that includes:
a bolt with a head;
wherein the head is sized to fit through the keyhole and slide within the channel;
wherein the bolt includes a threaded fastener post that extends from the head;
wherein the head is wider than the threaded fastener post;
a nut threaded onto the threaded fastener post; and
a clamp attachable to the rail, wherein the clamp includes:
an arm portion with a bore disposed therethrough for receiving the threaded fastener post, and
a hook extending from the arm portion for engaging a corresponding hook on the rail.

9. The tonneau cover holddown assembly of claim 8, wherein the clamp further comprises a first clamp flange positioned above the hook, extendable from the arm portion, and engageable with a first portion of the rail, and a second clamp flange extending from the hook transverse to the first clamp flange and engageable with a second portion of the rail.

10. The tonneau cover holddown assembly of claim 9, wherein when the hook engages the corresponding hook on the rail engagement of the first clamp flange with the first portion of the rail and the second clamp flange with the second portion of the rail prevent the clamp from falling off the rail during installation.

11. The tonneau cover holddown assembly of claim 8, wherein when the nut is tightened onto the threaded fastener post, the clamp is drawn toward the pocket assembly to further tighten the hook onto the corresponding hook of the rail to secure the bulkhead panel to the rail.

12. The tonneau cover holddown assembly of claim 8, wherein the bolt assembly includes a slider coupled thereto, wherein the slider is sized to fit through the keyhole and slide within the channel.

13. The tonneau cover holddown assembly of claim 8, wherein the pocket assembly includes one or more relief tabs that extend from the pocket assembly and are supported by a side frame of the bulkhead panel.

14. The tonneau cover holddown assembly of claim 8, further comprising a holddown clamp locator disposed adjacent the pocket assembly, attached to the rail, and configured to longitudinally align the clamp on the rail.

15. The tonneau cover holddown assembly of claim 14, wherein the holddown clamp locator includes a first abutment that restricts a position of the clamp to a predetermined location on the rail.

16. The tonneau cover holddown assembly of claim 15, wherein the holddown clamp locator includes a second abutment spaced apart from the first abutment, wherein the clamp can be positioned between the first abutment and the second abutment to locate the clamp in the predetermined location on the rail and prevent the clamp from sliding along the rail.

17. The tonneau cover holddown assembly of claim 8, further comprising a second tonneau cover holddown assembly positioned on an opposite side of the bulkhead panel from the tonneau cover holddown assembly, wherein the second tonneau cover holddown assembly secures the bulkhead panel to a second rail on an opposing sidewall of the cargo box.

18. A tonneau cover holddown assembly for securing a bulkhead panel of a tonneau cover to a rail positioned on a sidewall of a cargo box of a truck, the tonneau cover holddown assembly comprising:
a slot disposed through an underside surface of the bulkhead panel, the slot including a keyhole in communication with the slot;
a bolt including a bolthead sized to fit through the keyhole and to slide within the slot;
wherein the bolthead is wider than the slot;
a threaded fastener post extending from the bolthead and a nut threaded onto the threaded fastener post;
a clamp attachable to the rail, the clamp including:
an arm portion with a bore disposed therethrough for receiving the threaded fastener post,
a hook extending from the arm portion for engaging a corresponding hook on the rail,
a first clamp flange positioned above the hook and engageable with a first portion of the rail,
a second clamp flange extending from the hook transverse to the first clamp flange and engageable with a second portion of the rail,
wherein, when the hook engages the corresponding hook on the rail, engagement of the first clamp flange with the first portion of the rail and the second clamp flange with the second portion of the rail prevent the clamp from falling off the rail during installation; and
wherein, when the nut is tightened onto the threaded fastener post, the clamp is drawn toward the slot to further tighten the hook onto the corresponding hook on the rail to secure the bulkhead panel to the rail.

19. The tonneau cover holddown assembly of claim 18, further comprising a pocket assembly disposed within the slot and configured to receive the bolthead.

20. The tonneau cover holddown assembly of claim 19, wherein the pocket assembly comprises one or more relief tabs configured to transfer clamping forces from the clamp to a side frame of the bulkhead panel.
